(19) United States
(12) Patent Application Publication
(10) Pub. No.: US 2012/0328005 A1
(43) Pub. Date: Dec. 27, 2012

(54) CONSTRUCTION OF COMBINED LIST USING TEMPORAL DISTANCE

(75) Inventors: Yue Yu, San Diego, CA (US); Xue Fang, San Diego, CA (US); Limin Wang, San Diego, CA (US); Krit Panusopone, San D, CA (US)

(73) Assignee: GENERAL INSTRUMENT CORPORATION, Horsham, PA (US)

(21) Appl. No.: 13/530,428

(22) Filed: Jun. 22, 2012

Related U.S. Application Data
(60) Provisional application No. 61/500,008, filed on Jun. 22, 2011.
(60) Provisional application No. 61/507,391, filed on Jul. 13, 2011.
(60) Provisional application No. 61/564,470, filed on Nov. 29, 2011.
(60) Provisional application No. 61/557,880, filed on Nov. 9, 2011.

(51) Int. Cl. H04N 7/36; H04N 7/34; H04N 7/38

(52) U.S. Cl. 375/240.03; 375/240.12; 375/240.15; 375/E07.255; 375/E07.245

(57) ABSTRACT

In one embodiment, a method receives a current picture of video content. The method then determines a set of reference pictures for the current picture and a temporal distance from the current picture for each of the set of reference pictures. A combined list of reference pictures in the set of reference pictures is determined where an order of pictures in the combined list is based on the temporal distance for each of the set of reference pictures to the current picture. The method then uses the combined list to perform temporal prediction for the current picture.

### CROSS REFERENCE TO RELATED APPLICATIONS

The present application claims priority to:

U.S. Provisional App. No. 61/500,008 for “The Construction of Combined List for HEVC” filed Jun. 22, 2011;

U.S. Provisional App. No. 61/507,391 for “Reference Picture Indexing for Combined Reference List for HEVC” filed Jul. 13, 2011;

U.S. Provisional App. No. 61/564,470 for “The Reference Picture Construction of Combined List for HEVC” filed Nov. 29, 2011; and

U.S. Provisional App. No. 61/557,880 for “The Reference Picture Construction of Combined List for HEVC” filed Nov. 9, 2011, the contents of all of which are incorporated herein by reference in their entirety.

### BACKGROUND

Video compression systems employ block processing for most of the compression operations. A block is a group of neighboring pixels and may be treated as one coding unit in terms of the compression operations. Theoretically, a larger coding unit is preferred to take advantage of correlation among immediate neighboring pixels. Various video compression standards, e.g., Motion Picture Expert Group (MPEG)-1, MPEG-2, and MPEG-4, use block sizes of 4×4, 8×8, and 16×16 (referred to as a macroblock (MB)).

High efficiency video coding (HEVC) is also a block-based hybrid spatial and temporal predictive coding scheme. HEVC partitions an input picture into square blocks referred to as largest coding units (LCUs) as shown in FIG. 1. Unlike prior coding standards, the LCU can be as large as 128×128 pixels. Each LCU can be partitioned into smaller square blocks called coding units (CUs). FIG. 2 shows an example of an LCU partition of CUs. An LCU 100 is first partitioned into four CUs 102. Each CU 102 may also be further split into four smaller CUs 102 that are a quarter of the size of the CU 102. This partitioning process can be repeated based on certain criteria, such as limits to the number of times a CU can be partitioned may be imposed. As shown, CUs 102-1, 102-3, and 102-4 are a quarter of the size of LCU 100. Further, a CU 102-2 has been split into four CUs 102-5, 102-6, 102-7, and 102-8.

Each CU 102 may include one or more prediction units (PUs). FIG. 3 shows an example of a CU partition of PUs. The PUs may be used to perform spatial prediction or temporal prediction. A CU can be either spatially or temporally predictive coded. If a CU is coded in intra mode, each PU of the CU can have its own spatial prediction direction. If a CU is coded in inter mode, each PU of the CU can have its own motion vector(s) and associated reference picture(s).

Similar to other video coding standards, HEVC supports intra picture, such as I picture, and inter picture, such as B picture. Intra picture is coded without referring to other pictures. Hence, only spatial prediction is allowed for a CU/PU inside an intra picture. Intra picture provides a possible point where decoding can begin. On the other hand, inter picture aims at high compression. Inter picture supports both intra and inter prediction. A CU/PU in inter picture is either spatially or temporally predictive coded. Temporal references are the previously coded intra or inter pictures.

In the HEVC, there are two possible prediction modes for inter partition in the generalized B slices. One is bi-directional prediction, Pred_BI, with two reference lists of list 0 and list 1 and the other is uni-directional prediction, Pred_LC, with a single combined reference list. A syntax element, inter_pred_flag at the PU level, indicates which mode is used. If inter_pred_flag is set to 1, bi-directional prediction with two reference lists (Pred_BI) is used. If inter_pred_flag is set to 0, uni-directional prediction (Pred_LC) with a single combined list is used.

The combined list is constructed by interleaving the entries of list 0 and list 1 in ascending order of the indices, beginning with the smallest index of list 0. Indices pointing to the reference pictures that have already been included in the combined list will be skipped.

### SUMMARY

In one embodiment, a method receives a current picture of video content. The method then determines a set of reference pictures for the current picture and a temporal distance from the current picture for each of the set of reference pictures. A combined list of reference pictures in the set of reference pictures is determined where an order of pictures in the combined list is based on the temporal distance for each of the set of reference pictures to the current picture. The method then uses the combined list to perform temporal prediction for the current picture.

In one embodiment, an apparatus is provided comprising: one or more computer processors; and a computer-readable storage medium comprising instructions, that when executed, control the one or more computer processors to be configured for: receiving a current picture of video content; determining a set of reference pictures for the current picture; determining a temporal distance from the current picture for each of the set of reference pictures; generating a combined list of reference pictures in the set of reference pictures, wherein an order of pictures in the combined list is based on the temporal distance for each of the set of reference pictures to the current picture; and using the combined list to perform temporal prediction for the current picture.

In one embodiment, a non-transitory computer-readable storage medium if provided comprising instructions, that when executed, control the one or more computer processors to be configured for: receiving a current picture of video content; determining a set of reference pictures for the current picture; determining a temporal distance from the current picture for each of the set of reference pictures; generating a combined list of reference pictures in the set of reference pictures, wherein an order of pictures in the combined list is based on the temporal distance for each of the set of reference pictures to the current picture; and using the combined list to perform temporal prediction for the current picture

The following detailed description and accompanying drawings provide a better understanding of the nature and advantages of particular embodiments.

### BRIEF DESCRIPTION OF THE DRAWINGS

FIG. 1 shows partitions of an input picture into square blocks referred to as largest coding units (LCUs).

FIG. 2 shows an example of an LCU partition of CUs.

FIG. 3 shows an example of a CU partition of PUs.

FIG. 4 depicts an example of a system for encoding and decoding video content according to one embodiment.

FIG. 5 shows an example of a sequence of pictures from video content that is displayed in a display order from left to right according to one embodiment.

FIG. 6 depicts a simplified flowchart of a method for determining a combined list according to one embodiment.

FIG. 7 depicts an example of a sequence of pictures according to one embodiment.

FIG. 8 depicts a sequence of pictures according to one embodiment.

FIG. 9A depicts an example of encoder according to one embodiment.

FIG. 9B depicts an example of decoder according to one embodiment.

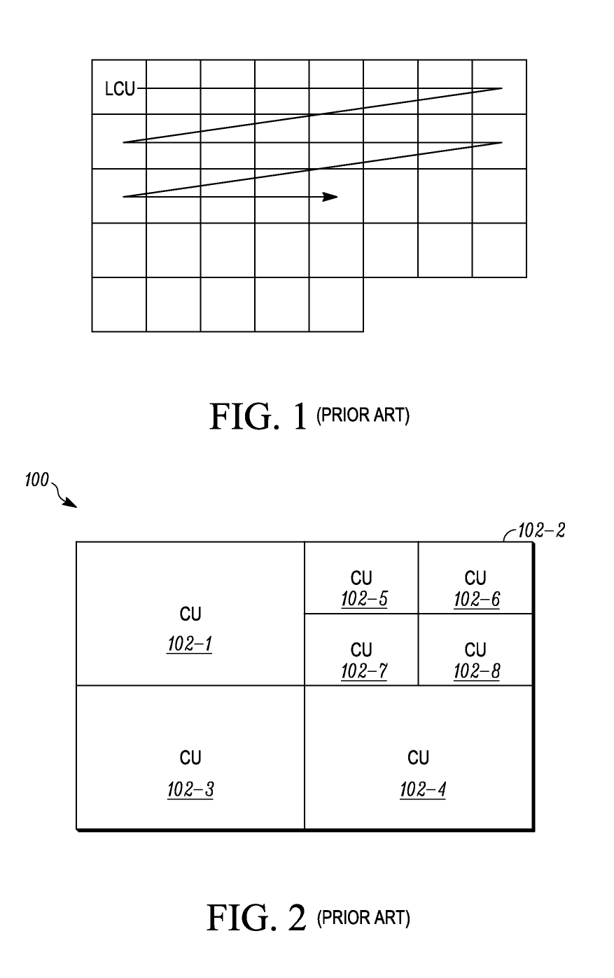

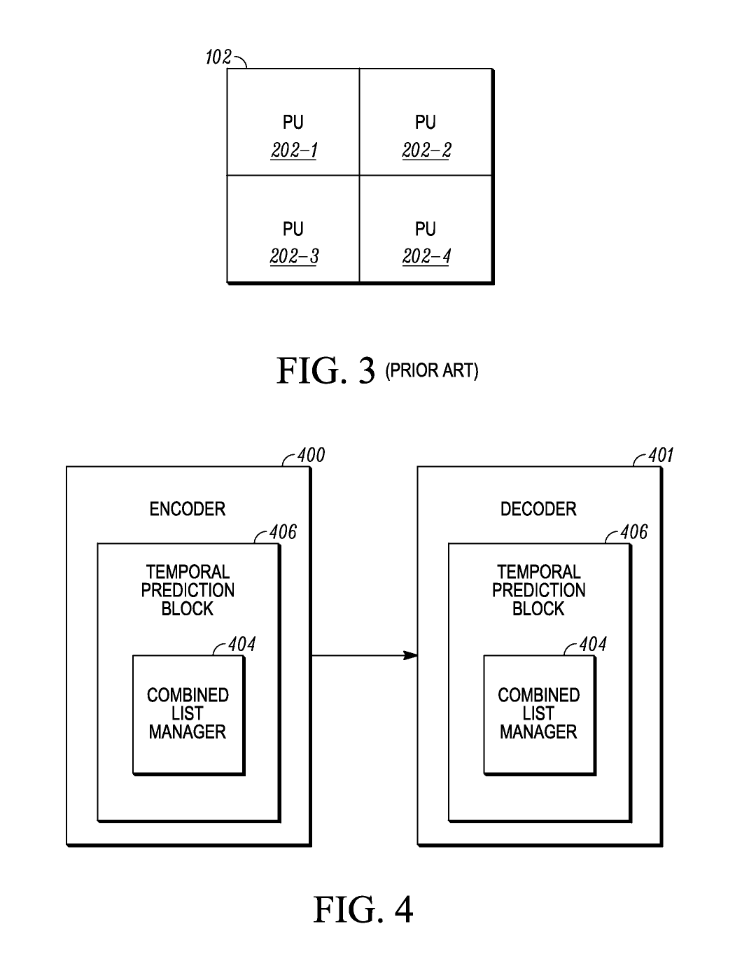

### DETAILED DESCRIPTION

Described herein are techniques for a video compression system. In the following description, for purposes of explanation, numerous examples and specific details are set forth in order to provide a thorough understanding of particular embodiments. Particular embodiments as defined by the claims may include some or all of the features in these examples alone or in combination with other features described below, and may further include modifications and equivalents of the features and concepts described herein.

### Generation of Combined Lists Using Temporal Distance

FIG. 4 depicts an example of a system for encoding and decoding video content according to one embodiment. The system includes an encoder 400 and a decoder 401, both of which will be described in more detail below.

A temporal prediction block 406 in either encoder 400 or decoder 401 is used to perform temporal prediction. In temporal prediction, reference pictures from the combined list may be selected as reference pictures for a current picture when performing uni-directional prediction motion estimation. Reference pictures that are at lower indices in the combined list may be more similar to the current picture and may take less bits to encode the current picture if the reference picture at lower indices are used.

Particular embodiments use a combined list manager 404 in either encoder 400 or decoder 401 to construct a combined list to improve coding efficiency. In one embodiment, the combined list may be used when two or more (but not necessary two or more, can be one) consecutive non-reference (but not necessary non-reference, it also can be reference picture for other picture) pictures are found in a video sequence. As described above, the combined list may be generated from entries that would be found in two lists, list 0 and list 1. In one embodiment, the combined list is generated by determining a reference picture with a shortest temporal distance from a current picture. This reference picture is assigned the lowest reference index in the combined list, such as reference index 0. The second reference picture with a second shortest temporal distance from the current picture is then determined and assigned the next reference index, reference index 1. This process continues as reference pictures with shorter temporal distances from the current picture are assigned smaller reference indices. This index assignment is performed because it is likely that blocks in the current picture that are closer than more distant reference pictures will be more similar to the those reference pictures. Using similar pictures in motion estimation may increase coding efficiency because a similar block is more likely to be found in pictures that are temporally closer. In one embodiment, if two reference pictures have the same temporal distance from the current picture, different algorithms may be used to select one of the reference pictures. For example, the reference picture that is in the past is assigned a smaller reference index.

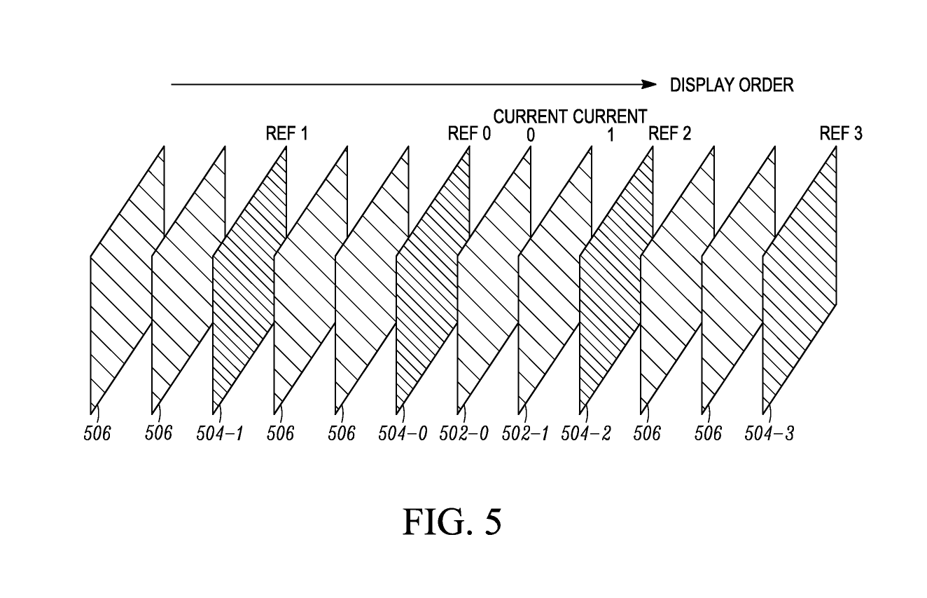

FIG. 5 shows an example of a sequence of pictures from video content that is displayed in a display order from left to right according to one embodiment. The left side of current pictures 502-0 and 502-1 represents pictures that are displayed before pictures to the right side of current pictures 502-0 and 502-1. A current picture is a picture currently being coded. Although current pictures 502-0 and 502-1 are referred to as “current” pictures, it will be understood that only one picture may currently be coded. Thus, both current pictures 502-0 and 502-1 may be coded at different times. Reference pictures 504-0-504-3 are reference pictures for current pictures 502-0 and 502-1. Reference pictures are used in motion estimation operations. For example, a block in reference pictures 504 that is similar to a block in current picture 502 is searched for during motion estimation. Additional pictures 506 are also shown. Pictures 506 may be non-reference pictures.

Current pictures 502-0 and 502-1 have four reference pictures, reference pictures 504-0, 504-1, 504-2, and 504-3. If two reference lists are used, reference indices for list 0 and list 1 are the same for current pictures 502-0 and 502-1. For example, the two separate reference lists for both current pictures 502-0 and 502-1 are:

$$\{ \begin{matrix}{list}_{0} [ 0 ] = {ref}_{0} \\ {list}_{0} [ 1 ] = {ref}_{1} \\ {list}_{0} [ 2 ] = {ref}_{2} \\ {list}_{0} [ 3 ] = {ref}_{3}\end{matrix}$$

Reference indices for Ref0, Ref1, Ref2 and Ref3 in list 0.

$$\{ \begin{matrix}{list}_{1} [ 0 ] = {ref}_{2} \\ {list}_{1} [ 1 ] = {ref}_{3} \\ {list}_{1} [ 2 ] = {ref}_{0} \\ {list}_{1} [ 3 ] = {ref}_{1}\end{matrix}$$

Reference indices for Ref0, Ref1, Ref2 and Ref3 in list 1.

However, if a combined list is used, current picture 502-0 and current picture 502-1 will have different combined lists because the combined list is constructed according to the temporal distances between a current picture and its reference pictures 504. For current picture 502-0, reference picture 504-0 is assigned index 0 in the combined list because reference picture 504-0 is temporally closest to current picture 502-0. Reference picture 504-2 is assigned index 1 because reference picture 504-2 is the second temporally closest picture to current picture 502-0. Reference pictures 504-1 and 504-3 are then assigned indices 2 and 3, respectively, because reference picture 504-1 is temporally closer to current picture 502-0 than reference picture 504-3. The combined list for current picture 502-0 is as follows:

$$\{ \begin{matrix}{list}_{current 0} [ 0 ] = {ref}_{0} \\ {list}_{current 0} [ 1 ] = {ref}_{2} \\ {list}_{current 0} [ 2 ] = {ref}_{1} \\ {list}_{current 0} [ 3 ] = {ref}_{3}\end{matrix}$$

### Combined List for Current Picture 502-0

For current picture 502-1, reference picture 504-2 is assigned index 0 because reference picture 504-2 is temporally closest to current picture 502-1. Reference picture 504-0 is assigned index 1 because reference picture 504-0 is the second temporally closest picture to current picture 502-1. Reference pictures 504-3 and 504-1 are assigned indices 2 and 3, respectively, because reference picture 504-3 is temporally closer to current picture 502-1 than reference picture 504-1. The combined list for current picture 502-1 is as follows:

$$\{ \begin{matrix}{list}_{current 1} [ 0 ] = {ref}_{2} \\ {list}_{current 1} [ 1 ] = {ref}_{0} \\ {list}_{current 1} [ 2 ] = {ref}_{3} \\ {list}_{current 1} [ 3 ] = {ref}_{1}\end{matrix}$$

### Combined List for Current Picture 502-1

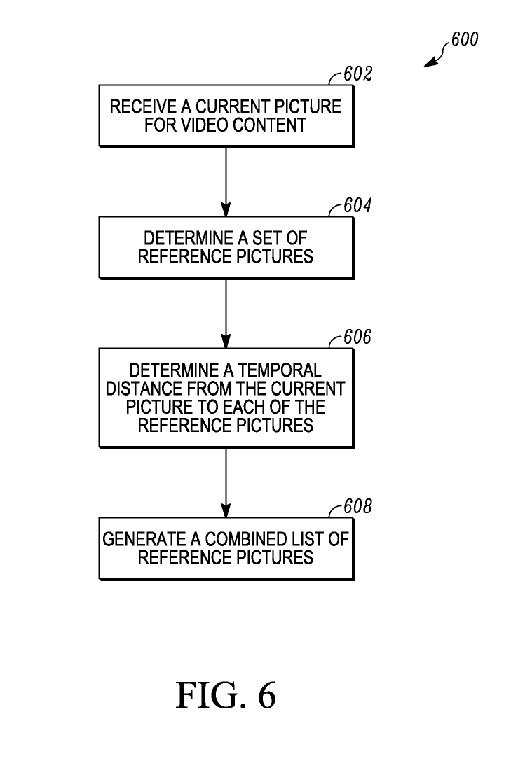

FIG. 6 depicts a simplified flowchart 600 of a method for determining a combined list according to one embodiment. At 602, combined list manager 404 receives a current picture 502 for video content. At 604, combined list manager 404 determines a set of reference pictures. For example, the set of reference pictures may include a first set of reference pictures that are in the past as compared to current picture 502-0 and a second set of reference pictures 504 that are in the future as compared to current picture 502.

At 606, combined list manager 404 determines a temporal distance from current picture 502 to each of the reference pictures 504. For example, the temporal distance may be computed and the list of reference pictures 504 may be sorted. The sorted list may resolve ties where reference pictures 504 from the past are put before reference pictures 504 in the future in the list.

At 608, combined list manager 404 generates a combined list of reference pictures 504. Combined list manager 404 inserts pictures into the combined list according to the sorted list. Once the combined list is generated, temporal prediction block 406 may perform temporal prediction using the combined list for current picture 502.

### Generation of Combined Lists Using Quantization Parameters (QPs)

In one embodiment, combined list manager 404 generates the combined list based on the temporal distances to current picture 502 and may also take into account quantization parameters for reference pictures 504. For example, average quantization parameters for reference pictures 504 may be taken into account. The quantization parameter regulates how much spatial detail is saved. When a quantization parameter is very small, almost all of the detail in a picture is retained. As the quantization parameter is increased, some of the detail in the bitstream is aggregated so that the bit rate drops, which results in an increase in distortion and some loss of quality. The different quantization parameters may be based on different coding levels. The coding level may be the amount of redundancy that is included in each reference picture 504.

When two reference pictures 504 have the same temporal distances, then the reference picture 504 with the smallest quantization parameter is inserted in the combined list at a lower index than the other reference picture 504. This is done because the quality may be better for a reference picture 504 that has a smaller quantization parameter.

In one embodiment, as described above, given a current picture 502, if two reference pictures 504 have different temporal distances from a current picture 502, reference picture 504 with a shorter temporal distance from current picture 502 is assigned a smaller reference index. If two reference pictures 504 have the same temporal distance from current picture 502, then the reference picture 504 with a smaller quantization parameter (e.g., average quantization parameter) is assigned a smaller reference index. Also, if two reference pictures 504 have the same temporal distance from current picture 502 and the same average quantization parameters (the average quantization parameters may be within a certain range or threshold to be the same), the reference picture 504 in the past is assigned a smaller reference index in the combined list.

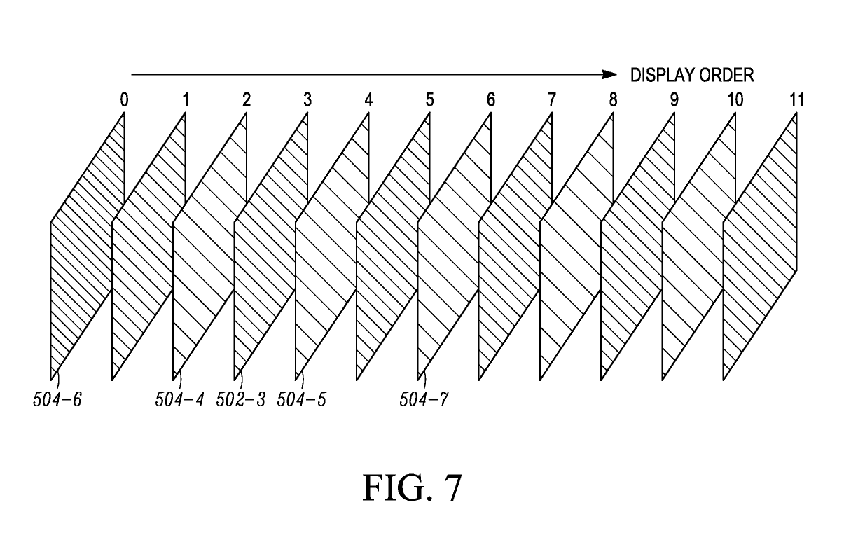

FIG. 7 depicts an example of a sequence of pictures according to one embodiment. A current picture 502-3 is currently being coded. Reference pictures 504-4 and 504-5 are both reference pictures for current picture 502-3. The temporal distance between reference picture 504-4 and current picture 502-3 is the same as the temporal distance between reference picture 504-5 and current picture 502-3. However, an average quantization parameter for reference picture 504-5 is smaller than that of reference picture 504-4, and thus reference picture 504-5 is assigned a smaller reference index in the combined list than reference picture 504-4. For example, reference picture 504-5 is assigned index 0 and reference picture 504-4 is assigned index 1.

Additionally, reference pictures 504-6 and 504-7 are reference pictures for current picture 502-3. The temporal distances from reference picture 504-6 to current picture 502-3 is the same as the temporal distance from reference picture 504-7 to current picture 502-3. The quantization parameter for reference picture 504-6 is smaller than that of reference picture 504-7, and thus reference picture 504-6 is assigned a smaller reference index than reference picture 504-7 in the combined reference list. For example, index 2 may be assigned to reference picture 504-6 and index 3 is assigned to reference picture 504-7.

In another example, the quantization parameters may be used without taking into account temporal distance. In this case, the smaller quantization parameters for reference pictures 504 have lower indices in the combined list.

### Generation of Combined List Using POC

Combined list manager 404 uses a picture order count (POC) to determine the combined list according to one embodiment. Also, a delta POC may be used to determine the combined list. The POC specifies the picture order count according to display order. Delta POC is the difference between the POC of current picture 502 and reference picture 504. In one example, because the difference is taken, the absolute value of the delta POC is used because some POCs will be negative. The POC or delta POC can be used to represent the temporal distance between a current picture 502 and a reference picture 504 in list 0 or list 1. For example, the lowest absolute value of the delta POCs may represent the closest reference pictures 504 to current picture 502.

Given a current picture 502 with two reference lists, the combined reference list may be formed by reviewing the absolute value of the delta POCs of reference pictures 504. The reference pictures 504 with the smaller absolute value of the delta POCs are added to the list with lower index numbers. If two absolute values of the delta POCs have the same absolute value in the two lists, then, in one embodiment, reference picture 504 in the past is assigned a smaller reference index. By using the absolute value of the delta POCs, reference pictures 504 with shorter temporal distances from current pictures 502 are assigned smaller reference indices.

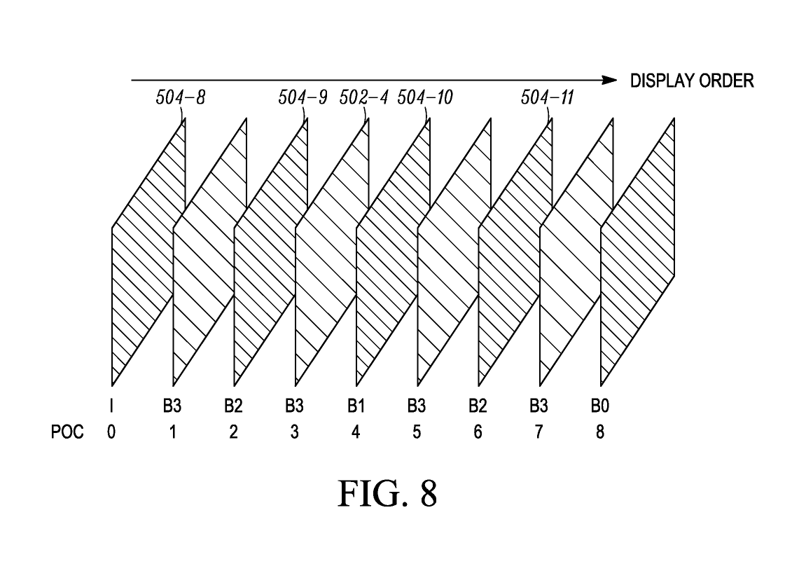

FIG. 8 depicts a sequence of pictures according to one embodiment. A current picture 502-4 is being encoded or decoded. A list 0 for current picture 502-4 includes reference pictures in the order of POC of reference picture 504-8, reference picture 504-9, and reference picture 504-10. A list 1 for current picture 502-4 is reference picture 504-10, reference picture 504-11, and reference picture 504-9. The conventional method may generate the combined list of reference picture 504-8, reference picture 504-10 and reference picture 504-9. This is due to the sequential selecting of reference pictures from both lists. However, particular embodiments use the absolute value of the delta POC and QP to select the combined list to be reference picture 504-10, reference picture 504-8, and reference picture 504-9. In this case, the absolute value of the delta POC between reference picture 502-4 and reference picture 504-10 is same as the absolute value of the delta POC between reference picture 502-4 and reference picture 504-9. The QP may be taken into account then. The QP for reference picture 504-10 is smaller than the QP for reference picture 504-9. As a result, reference picture 504-10 is put as the first entry of combined list. Regarding reference picture 504-8 and reference picture 504-9, because the QP for reference picture 504-8 (I picture) is much smaller than reference picture 504-9 (B picture), reference picture 504-8 is put before reference picture 504-9.

### Encoder and Decoder Examples

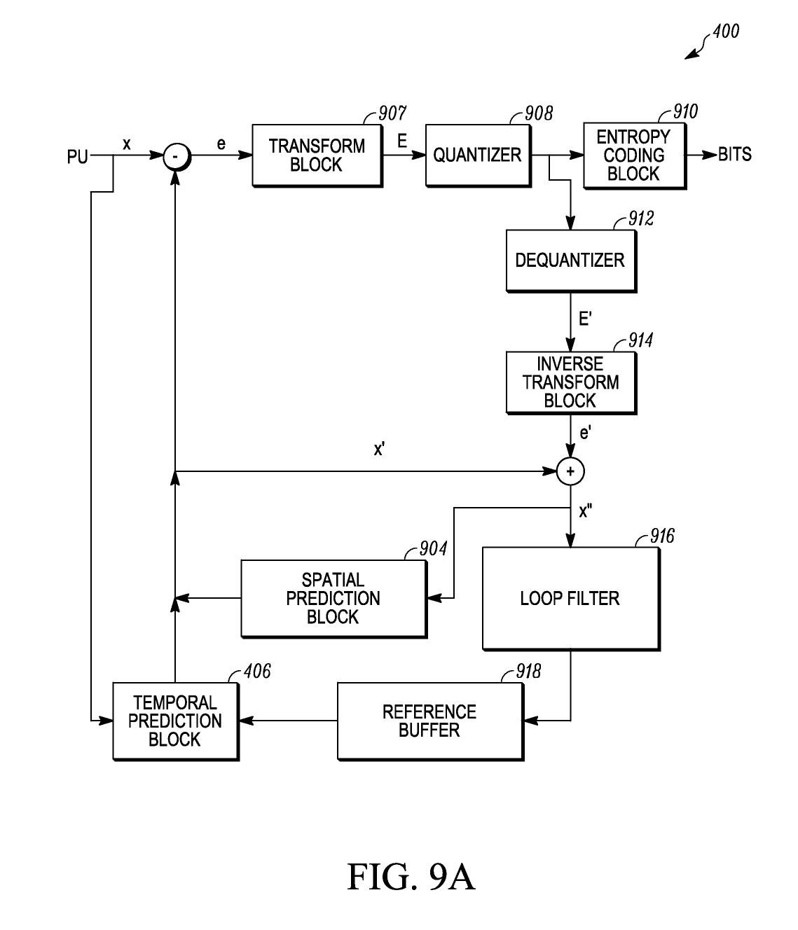

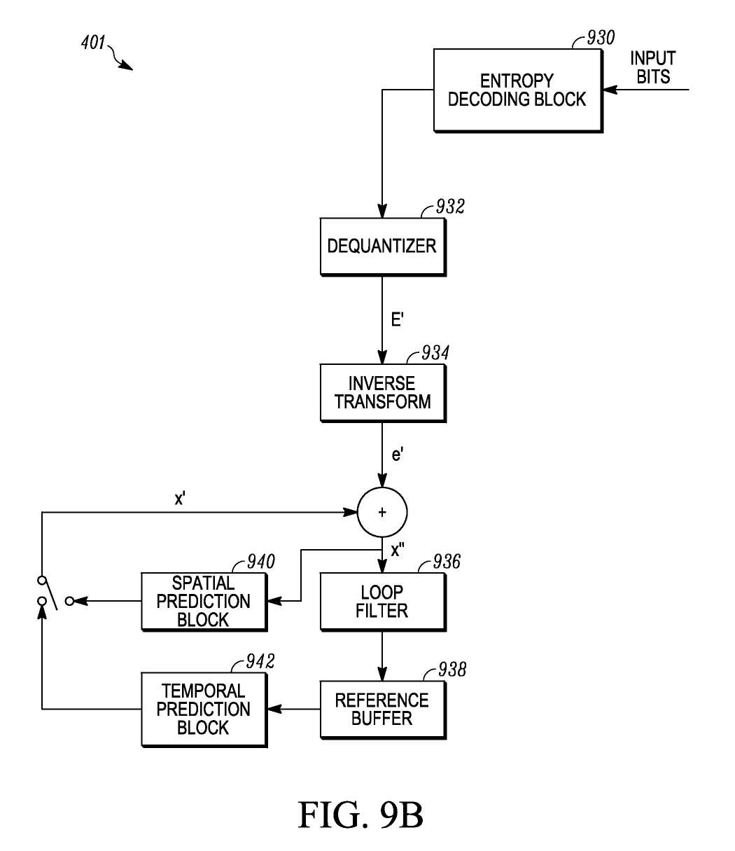

FIG. 9A depicts an example of encoder 400 according to one embodiment. A general operation of encoder 400 will now be described; however, it will be understood that variations on the encoding process described will be appreciated by a person skilled in the art based on the disclosure and teachings herein.

For a current PU, x, a prediction PU, x′, is obtained through either spatial prediction or temporal prediction. The prediction PU is then subtracted from the current PU, resulting in a residual PU, e. A spatial prediction block 904 may include different spatial prediction directions per PU, such as horizontal, vertical, 45-degree diagonal, 135-degree diagonal, DC (flat averaging), and planar.

Temporal prediction block 406 performs temporal prediction through a motion estimation operation. The motion estimation operation searches for a best match prediction for the current PU over reference pictures. The best match prediction is described by a motion vector (MV) and associated reference picture (refldx). The motion vector and associated reference picture are included in the coded bit stream.

Transform block 907 performs a transform operation with the residual PU, e. Transform block 907 outputs the residual PU in a transform domain, E.

A quantizer 908 then quantizes the transform coefficients of the residual PU, E. Quantizer 908 converts the transform coefficients into a finite number of possible values. Entropy coding block 910 entropy encodes the quantized coefficients, which results in final compression bits to be transmitted. Different entropy coding methods may be used, such as context-adaptive variable length coding (CAVLC) or context-adaptive binary arithmetic coding (CABAC).

Also, in a decoding process within encoder 400, a de-quantizer 912 de-quantizes the quantized transform coefficients of the residual PU. De-quantizer 912 then outputs the de-quantized transform coefficients of the residual PU, E′. An inverse transform block 914 receives the de-quantized transform coefficients, which are then inverse transformed resulting in a reconstructed residual PU, e′. The reconstructed PU, e′, is then added to the corresponding prediction, x′, either spatial or temporal, to form the new reconstructed PU, x″. A loop filter 916 performs de-blocking on the reconstructed PU, x″, to reduce blocking artifacts. Additionally, loop filter 916 may perform a sample adaptive offset process after the completion of the de-blocking filter process for the decoded picture, which compensates for a pixel value offset between reconstructed pixels and original pixels. Also, loop filter 916 may perform adaptive loop filtering over the reconstructed PU, which minimizes coding distortion between the input and output pictures. Additionally, if the reconstructed pictures are reference pictures, the reference pictures are stored in a reference buffer 918 for future temporal prediction.

FIG. 9B depicts an example of decoder 401 according to one embodiment. A general operation of decoder 401 will now be described; however, it will be understood that variations on the decoding process described will be appreciated by a person skilled in the art based on the disclosure and teachings herein. Decoder 401 receives input bits from encoder 400 for encoded video content.

An entropy decoding block 930 performs entropy decoding on the input bitstream to generate quantized transform coefficients of a residual PU. A de-quantizer 932 de-quantizes the quantized transform coefficients of the residual PU. De-quantizer 932 then outputs the de-quantized transform coefficients of the residual PU, E′. An inverse transform block 934 receives the de-quantized transform coefficients, which are then inverse transformed resulting in a reconstructed residual PU, e′.

The reconstructed PU, e′, is then added to the corresponding prediction, x′, either spatial or temporal, to form the new reconstructed PU, x″. A loop filter 936 performs de-blocking on the reconstructed PU, x″, to reduce blocking artifacts. Additionally, loop filter 936 may perform a sample adaptive offset process after the completion of the de-blocking filter process for the decoded picture, which compensates for a pixel value offset between reconstructed pixels and original pixels. Also, loop filter 936 may perform adaptive loop filtering over the reconstructed PU, which minimizes coding distortion between the input and output pictures. Additionally, if the reconstructed pictures are reference pictures, the reference pictures are stored in a reference buffer 938 for future temporal prediction.

The prediction PU, x′, is obtained through either spatial prediction or temporal prediction. A spatial prediction block 940 may receive decoded spatial prediction directions per PU, such as horizontal, vertical, 45-degree diagonal, 135-degree diagonal, DC (flat averaging), and planar. The spatial prediction directions are used to determine the prediction PU, x′.

A temporal prediction block 406 performs temporal prediction through a motion estimation operation. A decoded motion vector is used to determine the prediction PU, x′. Interpolation may be used in the motion estimation operation.

Particular embodiments may be implemented in a non-transitory computer-readable storage medium for use by or in connection with the instruction execution system, apparatus, system, or machine. The computer-readable storage medium contains instructions for controlling a computer system to perform a method described by particular embodiments. The instructions, when executed by one or more computer processors, may be operable to perform that which is described in particular embodiments.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. The above examples and embodiments should not be deemed to be the only embodiments, and are presented to illustrate the flexibility and advantages of particular embodiments as defined by the following claims. Based on the above disclosure and the following claims, other arrangements, embodiments, implementations and equivalents may be employed without departing from the scope hereof as defined by the claims.

What is claimed is:

1. A method comprising:
receiving a current picture of video content;
determining a set of reference pictures for the current picture;
determining, by a computing device, a temporal distance from the current picture for each of the set of reference pictures;
generating, by the computing device, a combined list of reference pictures in the set of reference pictures, wherein an order of pictures in the combined list is based on the temporal distance for each of the set of reference pictures to the current picture; and
using, by the computing device, the combined list to perform temporal prediction for the current picture.

2. The method of claim 1, wherein the set of references pictures include a first set of references pictures at a past time as compared to the current picture and a second set of references picture that are at a future time as compared to the current picture.

3. The method of claim 2, wherein the first set of reference pictures are in a first list and the second set of reference pictures are in a second list for use when bi-prediction is used in temporal prediction.

4. The method of claim 1, wherein the current and another current picture are consecutive pictures in the video content.

5. The method of claim 4, wherein the combined list for the current picture is different from a combined list for another current picture due to different temporal distances from pictures in the set of reference pictures to the current picture and the another current picture, respectively.

6. The method of claim 1, wherein reference pictures in the set of reference pictures are included the combined list in an order of shortest temporal distance to the current picture.

7. The method of claim 1, wherein if two in the set of reference pictures have a same temporal distance, one of the two reference pictures at a past time to the current picture is inserted in the combined list with a lower index.

8. The method of claim 1, wherein if two pictures in the set of reference pictures have a same temporal distance, one of the two pictures with a smaller quantization parameter is inserted in the combined list with a lower index.

9. The method of claim 1, wherein:
determining the temporal distance from the current picture for each of the set of reference pictures comprises determining a delta picture order count (POC) for each picture in the set of reference pictures, and
the order of pictures in the combined list is based on the delta POC for each of the set of reference pictures to the current picture.

10. The method of claim 9, wherein the order of pictures in the combined list includes pictures from the set of reference pictures with smaller delta POCs first.

11. The method of claim 10, wherein the delta POC for each of the set of reference pictures is an absolute value of the delta POC.

12. An apparatus comprising:
one or more computer processors; and
a computer-readable storage medium comprising instructions, that when executed, control the one or more computer processors to be configured for:
receiving a current picture of video content;
determining a set of reference pictures for the current picture;
determining a temporal distance from the current picture for each of the set of reference pictures;
generating a combined list of reference pictures in the set of reference pictures, wherein an order of pictures in the combined list is based on the temporal distance for each of the set of reference pictures to the current picture; and
using the combined list to perform temporal prediction for the current picture.

13. The apparatus of claim 12, wherein the set of references pictures include a first set of references pictures at a past time as compared to the current picture and a second set of references picture that are at a future time as compared to the current picture.

14. The apparatus of claim 13, wherein the first set of reference pictures are in a first list and the second set of reference pictures are in a second list for use when bi-prediction is used in temporal prediction.

15. The apparatus of claim 12, wherein:
the current picture and another current picture are consecutive pictures in the video content, and
the combined list for the current picture is different from a combined list for another current picture due to different temporal distances from pictures in the set of reference pictures to the current picture and the another current picture, respectively.

16. The apparatus of claim 12, wherein reference pictures in the set of reference pictures are included the combined list in an order of shortest temporal distance to the current picture.

17. The apparatus of claim 12, wherein if two in the set of reference pictures have a same temporal distance, one of the two reference pictures at a past time to the current picture is inserted in the combined list with a lower index.

18. The apparatus of claim 15, wherein if two pictures in the set of reference pictures have a same temporal distance, one of the two pictures with a smaller quantization parameter is inserted in the combined list with a lower index.

19. The apparatus of claim 15, further comprising:
determining the temporal distance from the current picture for each of the set of reference pictures comprises determining a delta picture order count (POC) for each picture in the set of reference pictures, and
the order of pictures in the combined list is based on an absolute value of the delta POC for each of the set of reference pictures to the current picture.

20. A non-transitory computer-readable storage medium comprising instructions, that when executed, control the one or more computer processors to be configured for:
receiving a current picture of video content;
determining a set of reference pictures for the current picture;
determining a temporal distance from the current picture for each of the set of reference pictures;
generating a combined list of reference pictures in the set of reference pictures, wherein an order of pictures in the combined list is based on the temporal distance for each of the set of reference pictures to the current picture; and
using the combined list to perform temporal prediction for the current picture.
